(19) United States
(12) Patent Application Publication
(10) Pub. No.: US 2012/0054602 A1
(43) Pub. Date: Mar. 1, 2012

(54) MANAGEMENT OF DISPLAY OF OBJECT FIELDS OF LAYOUT ELEMENTS

(75) Inventors: Hilmar Demant, Karlsdorf (DE); Sebastian Droll, Heidelberg (DE); Joachim Fitzer, Schriesheim (DE); Ioannis Grammatikakis, Maxdorf (DE); Jan Heiler, Walldorf (DE); Juergen Sattler, Wiesloch (DE); Frank Schertel, Mannheim (DE); Markus Viol, Walldorf (DE); Thorsten Weber, Mannheim (DE)

(73) Assignee: SAP AG, Walldorf (DE)

(21) Appl. No.: 12/871,394

(22) Filed: Aug. 30, 2010

(51) Int. Cl. G06F 17/00

(52) U.S. Cl. 715/247

(57) ABSTRACT

A computer system can include a data handler configured to receive data for display within a plurality of layout elements. Each layout element from the plurality of layout elements can be identified for display within an application. The computer system can include a boundary generator configured to associate a first plurality of variable-size fields with a first column and associate a second plurality of variable-size fields with a second column. Each layout element from the plurality of layout elements can include at least one variable-size field from the first plurality of variable-size fields and at least one variable-size field from the second plurality of variable-size fields. The boundary generator can be configured to define a pair of alignment boundaries using a predicted size of each of the variable-size fields from the first plurality of variable-size fields.

### TECHNICAL FIELD

This description relates to management of display of layout elements.

### BACKGROUND

Layout elements, which can be processed for display within specified locations within an application, can have various types of fields configured to contain objects for display. A field configured to include an object for display therein can be referred to as an object field. The layout elements may define, for example, at least a portion of a user interface of an application. When objects of different sizes are included within the fields from these layout elements, the fields may not be aligned in a desirable fashion. The misalignment may be caused by, for example, expansion of the dimensions of the various fields in a non-uniform fashion between different layout elements based on the varying sizes of the objects included within the fields. Thus, a need exists for systems, methods, and apparatus to address the shortfalls of present technology and to provide other new and innovative features.

### SUMMARY

According to one general aspect, a computer system can include instructions stored on a non-transitory computer-readable storage medium. The computer system can include a data handler configured to receive data for display within a plurality of layout elements. Each layout element from the plurality of layout elements can be identified for display within an application. The computer system can include a boundary generator configured to associate a first plurality of variable-size fields with a first column and associate a second plurality of variable-size fields with a second column. Each layout element from the plurality of layout elements can include at least one variable-size field from the first plurality of variable-size fields and at least one variable-size field from the second plurality of variable-size fields. The boundary generator can be configured to define a pair of alignment boundaries using a predicted size of each of the variable-size fields from the first plurality of variable-size fields. The predicted size of each of the variable-size fields from the first plurality of variable-size fields can be based on each of the variable-size fields from the first plurality of variable-size fields being populated with at least a portion of the data and being sized independent of the remaining variable-size fields from the first plurality of variable-size fields. The computer system can include an application display engine configured to align a boundary of each variable-size field from the first plurality of variable-size fields with a first alignment boundary from the pair of alignment boundaries. The application display engine can be configured to align a boundary of each variable-size field from the second plurality of variable-size fields with a second alignment boundary from the pair of alignment boundaries.

According to another general aspect, a method can include executing instructions recorded on a non-transitory computer-readable storage media using at least one processor. The method can include identifying a plurality of layout elements targeted for display within an application. The plurality of layout elements can include a first layout element including a first plurality of variable-size fields oriented along a first line. The plurality of layout elements can include a second layout element including a second plurality of variable-size fields oriented along a second line. The first plurality of variable-size fields from the first layout element can be defined such that defining of a variable-size portion of each variable-size field from the first plurality of variable-size fields, when populated with a first portion of data and displayed within the first layout element, is independent from defining of a variable-size portion of each variable-size field from the second plurality of variable-size fields when populated with a second portion of the data and displayed within the second layout element. The method can also include defining an alignment boundary non-parallel to the first line and non-parallel to the second line based on a set of variable-size fields that includes a subset of the first plurality of variable-size fields and a subset of the second plurality of variable-size fields.

According to yet another general aspect, a non-transitory computer-readable storage medium storing code representing instructions that when executed are configured to cause a processor to perform a process. The code can include code to receive a plurality of instructions defining a layout element stored in a layout element database. At least a portion of the plurality of instructions can define a variable-size field within the layout element. The code can also include code to receive a first data identified for display in a first instance of the variable-size field in a first instance of the layout element. The code can also include code to receive a second data identified for display in a second instance of the variable-size field in a second instance of the layout element, and code to predict that a size of a variable-size portion of the second instance of the variable-size field, when the second data is displayed within the second instance of the variable-size field, is greater than a size of a variable-size portion of the first instance of the variable-size field when the first data is displayed within the first instance of the variable-size field. The code can also include code to define an alignment boundary within an application based on the size of the variable-size portion of the second instance of the variable-size field. The application can be a placement target of the first instance of the layout element and the second instance of the layout element.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a layout manager configured to display fields of layout elements within an application.

FIG. 2 is a flowchart that illustrates a method for displaying fields within layout elements during a layout process.

FIG. 3A is a block diagram that illustrates display of variable-size fields and fixed-size fields of layout elements within an application when not aligned along one or more alignment boundaries.

FIG. 3B is a block diagram that illustrates display of the variable-size fields and fixed-size fields of layout elements shown in FIG. 3A when the variable-size fields are aligned along alignment boundaries.

FIG. 3C is a block diagram that illustrates master layout elements included in a layout element database.

FIG. 4 is a block diagram that illustrates alignment of variable-size fields of layout elements along alignment boundaries that are horizontally oriented.

FIG. 5 is a flowchart that illustrates a method for defining an alignment boundary during a layout process.

### DETAILED DESCRIPTION

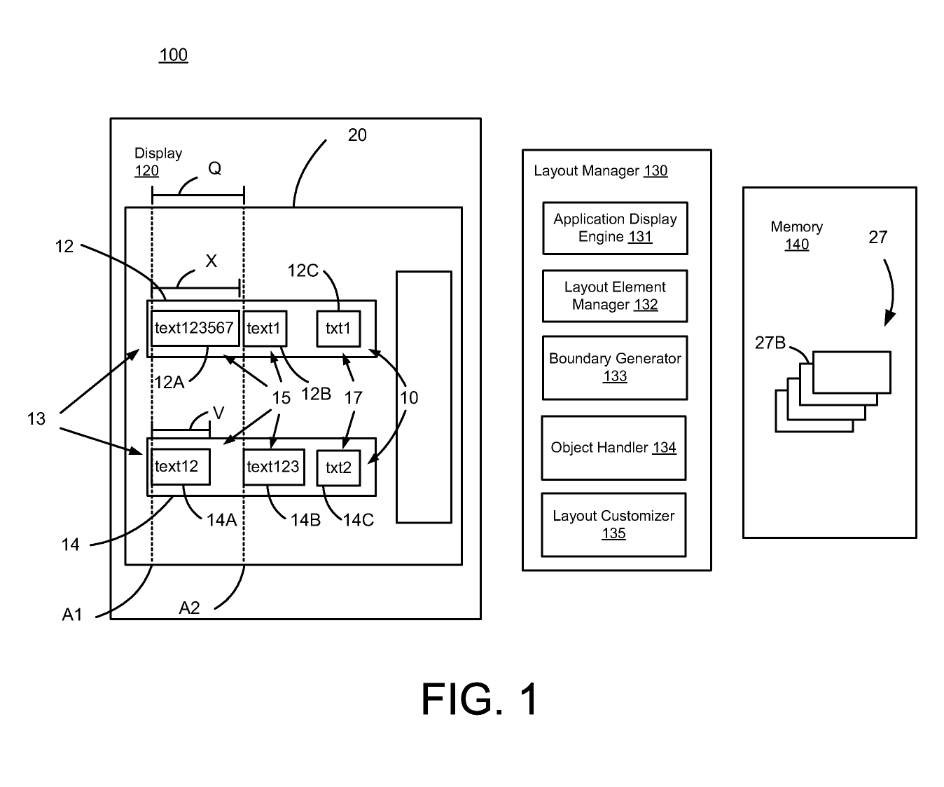

FIG. 1 is a block diagram of a layout manager 130 configured to display fields 10 of layout elements 13 within an application 20. The layout elements 13, and/or portions thereof (e.g., fields 10), can be logical elements (e.g., logical constructs) defined so that one or more objects may be displayed within each of the fields 10 of the layout elements 13 in a particular fashion. The fields 10 of the layout elements 13 can function as containers within which the object(s) can be inserted for display. The object(s) can be, for example, one or more images, data, and so forth. The data can be represented in the form of characters from, for example, the American Standard Code for Information Interchange (ASCII). The layout manager 130 is configured to display the fields 10 so that the fields 10, even though they are included in different layout elements 13 as shown in FIG. 1, may be aligned across the layout elements 13 even when objects of different sizes are included within the fields 10.

The layout manager 130 can be configured to display the fields 10 within multiple layout elements 13 of the application 20 so that at least some of the fields 10 are aligned along at least one of the alignment boundaries A1 and A2. Specifically, the layout manager is configured to display the fields 10 so that the fields 10, even though they are included in different layout elements 13, may be aligned in a desirable fashion when objects of different sizes are included within the fields 10. The processing of layout elements so that the fields 10 included therein are aligned along the alignment boundaries A1, A2 can be referred to as a layout process. Without the layout process described herein, the fields 10 of the layout elements 13 may be particularly misaligned in an undesirable fashion when the layout elements 13 are configured to be independently processed (e.g., executed) for display. In some embodiments, because the layout elements 13 can be independently processed, the layout elements 13 can be serially processed for display and/or processed for display in parallel with one another. A field configured to include an object to be displayed therein can be referred to as an object field. In some embodiments, some of the object fields can be referred to as form panes, list panes, section groups, and so forth.

Each of the layout elements 13 shown in FIG. 1 is an instance of the same master layout element 27B stored in the memory 140 within a library of master layout elements 27. Accordingly, layout element 12 can be referred to as an instance of the layout element 27B, or as an instance of the master layout element 27B. Similarly, layout element 14 can be referred to as an instance of the layout element 27B or as an instance of the master layout element 27B. The library of master layout elements 27 can define a layout element database (the layout element database can be referred to as a master layout element database). In some embodiments, a master layout element from the library of master layout elements 27 can be defined within an Extensible Markup Language (XML) file, an XML Schema Definition (XSD) file.

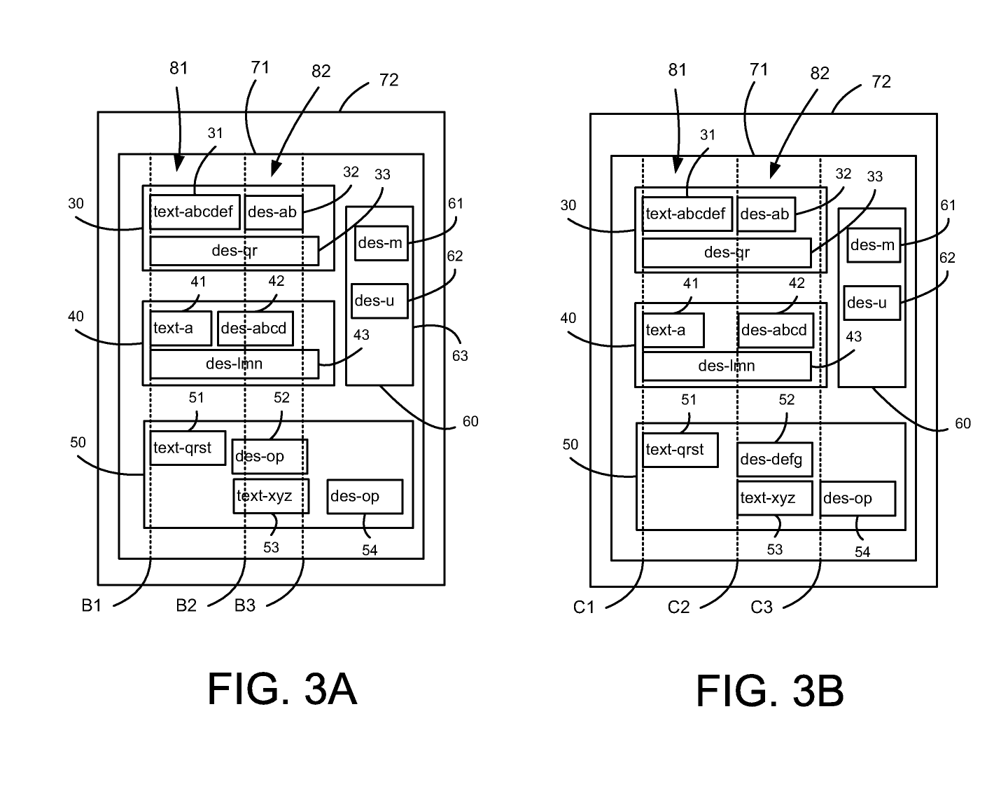

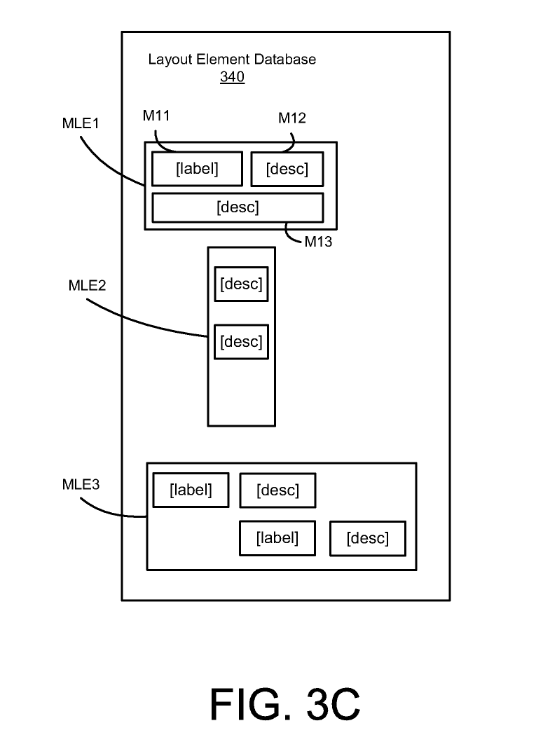

Management of the master layout elements 27 can be handled by a layout element manager 132 of the layout manager 130. For example, the layout element manager 132 can be configured to retrieve one or more of the master layout elements 27 in response to a request from another component from the layout manager 130. An example of master layout elements stored within a layout element database is described in more detail in connection with FIG. 3C.

As shown in FIG. 1, the layout element 12 includes fields 12A, 12B, and 12C, and layout element 14 includes fields 14A, 14B, and 14C. A field can be a location within which an object (e.g., a textual object) can be inserted for display. In some embodiments, the fields 10 can, for example, define a specified area, be defined by a specified area, and/or be included in a specified area. For example, as shown in FIG. 1, the text (also can be referred to as a textual object) “txt1” is displayed within field 12C, and the text is displayed within field 14B. The objects that are displayed within the fields 10 of the layout elements 13 shown in FIG. 1 are all textual objects. Although not shown, in some embodiments, multiple different types of objects, including textual objects, can be included within one or more of the fields 10.

An object handler 134 of the layout manager 130 can be configured to receive the objects that are to be included in the layout elements 13. In some embodiments, the object handler 134 can be configured to interface with the application 20 to determine (or receive instructions about) which objects should be included in the fields 10 of the layout elements 13. The object handler 134 of the layout manager 130 can be configured to interface with the other components of the layout manager 130 during the layout process.

The fields 10 included in the layout elements 13 are one of two types of fields—variable-size fields 15 or fixed-size fields 17. The fixed-size fields 17 have dimensions (e.g., horizontal and/or vertical dimension(s)) that are fixed (e.g., predefined), and the variable-size fields 15 have one or more dimensions (e.g., horizontal and/or vertical dimension(s)) that are defined based on one or more dimensions of the object included within the field. The dimension(s) of the variable-size field can be dynamically defined when an object is placed within the variable-size field for display within a display (such as display 120). The variable-size fields 15 include variable-size fields 12A, 12B, 14A, and 14B, and the fixed-size fields 17 include fixed-size fields 12C and 14C. In this embodiment, variable-size field 12A and the variable-size field 14A are instances of the same variable-size field (not shown) from the master layout element 27B. Similarly, fixed-size field 12C and fixed-size field 14C are instances of the same fixed-size field from the fixed-size field (not shown) from master layout element 27B.

Each of the master layout elements 27 is defined based on a set of instructions (not shown). Accordingly, each instance of the master layout elements 27 can be independently processed (e.g., executed, displayed) based on a common set of instructions. For example, portions of layout element 12 (e.g., variable-size fields 12A and 12B) can be determined and displayed based on the set of instructions associated with master element 27B independent of portions of layout element 14 (e.g., variable-size fields 14A and 14B). In some embodiments, the set of instructions can be, for example, XML-based instructions, a set of parameter values, executable code, and/or so forth.

The variable-size fields 15 are configured to be resized (e.g., expanded, contracted) according to the size of the object included within the variable-size fields 15. For example, variable-size field 12A and 14A, which are instances of the same variable-size field from master layout element 27B, when containing objects of different sizes can have different dimensions. Specifically, variable-size field 12A, which includes the text “text12356,” has a horizontal dimension X (also can be referred to as width X in this case) that has been sized to fit the text “text1234567.” The size of the variable-size field 12A is contrasted with the horizontal dimension of variable-size field 14A, which has a horizontal dimension V (also can be referred to as width V in this case) that is shorter than the horizontal dimension X. The horizontal dimension V is shorter than the horizontal dimension X because the horizontal dimension V of the variable-size field 14A is sized to fit the text “text12,” which is shorter than the text “text1234567.” In other words, because the text “text12” is shorter than the text “text1234567,” the sizes of the variable-size fields 12A and 14A are different from one another.

At least a portion of a set of instructions can define (e.g., specify) certain characteristics of a master layout element from the master layout elements 27 so that a size, a shape, an appearance (if visible), a basic orientation, and/or so forth, of instances of the master element can be defined. For example, a portion of the set of instructions can specify that master layout element 27B should have a specified (e.g., fixed, predefined) length (in a horizontal direction) and a specified (e.g., fixed, predefined) width (in a vertical direction). Accordingly, layout element 12 and layout element 14, which are both instances of master layout element 27B, have a specified length and a specified width when displayed within the display 120.

At least a portion of a set of instructions can also define (e.g., specify) a number, an appearance (if visible) a location, and type of fields within one or more of the master layout elements 27. For example, the set of instructions defining master layout element 27B can be used to define the number and types of fields within layout element 14, which is an instance of master element 27B. Although the fields 10 shown in FIG. 1 have edges that are visible, in some embodiments, one or more of the fields 10 may have edges that are not visible when displayed within the display 120. In other words, one or more of the fields 10 may define an area that may not be visible to, for example, a user when viewing the layout elements 13 when displayed within the display 120.

The layout manager 130 is configured to display the fields 10 (i.e., variable-size fields 15 and/or fixed-size fields 17) within the layout elements 13 of the application 20 so that fields 10, even though they may be included in different layout elements 13 and may have variable-sizes, may be aligned in a desirable fashion when objects are included within the fields 10. Because the variable-size fields 15 have one or more dimensions that depend on one or more dimensions of the objects included therein, the variable-size fields 15 and/or fixed-size fields 17 can be displayed in an undesirable (e.g., misaligned) fashion when objects of different sizes are included in the variable-size fields 15. Accordingly, the layout manager 130 has a boundary generator 133 configured to define boundaries A1 and A2 based one or more objects to be displayed within one or more of the variable-size fields 15. The boundaries A1 and A2 can be defined so that when the variable-size fields 15 are aligned along the respective boundaries A1 and A2 by the application display engine 131, the objects can be displayed within the variable-size-fields in a desirable fashion.

Boundary generator 133 can be configured to define the alignment boundaries A1 and A2 before the variable-size fields 12A and 14A (or any portions of the layout elements 13) are displayed. The alignment boundaries A1 and A2 are represented by dashed lines because, in this embodiment, the alignment boundaries are not actually displayed within the display 120. In some embodiments the alignment boundaries A1 and A2 can be configured so that they are displayed (at least temporarily) within the display 120.

Because layout element 12 and layout element 14 are independently processed based on the set of instructions defining master layout element 27B, and because the variable-size fields 15 have dimensions that depend on the dimensions of the objects displayed therein, the alignment boundaries (e.g., alignment boundary A2) may not be statically predefined. Specifically, the distance between the alignment boundaries A1 and A2 may not be statically predefined without calculating (e.g., predicting) the dimensions of the variable-size fields 15 when the respective objects are displayed therein. Instead, the distance between the alignment boundary A1 and the alignment boundary A2 are dynamically defined based on the predicted dimensions (e.g., predicted horizontal dimensions, predicted widths) of variable-size fields 12A and 14A when textual objects (i.e., “text1234567” and “text12”) are included within the variable-size fields 12A and 14A. In some embodiments, one or more of the variable-size fields 15 can have a minimum dimension as defined within, for example a set of instructions. In some embodiments, because the layout elements 13 can be independently processed, the layout elements 13 can be serially processed for display and/or processed for display in parallel with one another.

For example, before the variable-size fields 12A and 14A (or any portions of the layout elements 13) are displayed, a distance Q between the alignment boundary A1 and the alignment boundary A2 can be determined (e.g., defined, calculated) by the boundary generator 133 so that the predicted widths of each of the variable-size fields 12A and 14A, when textual objects “text1234567” and “text12” are respectively displayed therein, will be less than the distance Q between the alignment boundary A1 and the alignment boundary A2. Accordingly, when the variable-size fields 12B is displayed within the display 120, as shown in FIG. 1, the variable-size field 12B can be aligned along the alignment boundary A2 by the application display engine 131 of the layout manager 130 so that the variable-size field 12B will not overlap with the right edge of variable-size field 12A when the textual object “text1234567” is included in variable-size field 12A. Similarly, the variable-size field 14B (when actually displayed by the application display engine 131 of the layout manager 130) can be aligned along the alignment boundary A2 so that the variable-size field 14B will not overlap with the right edge of variable-size field 14A when the textual object “text12” is included in variable-size field 14A.

In this embodiment, the alignment boundary A1, which is the leftmost alignment boundary, has a location (e.g., a horizontal location within the application 20) that is statically predefined. After the distance Q between the alignment boundary A1 and the alignment boundary A2 has been defined by the boundary generator 133, the location of the alignment boundary A2 can be determined. In other words, the location of the alignment boundary A2 is determined based on the distance Q and the location of the alignment boundary A1, which functions as an initial alignment boundary (and can be referred to as such). In some embodiments, the locations of several alignment boundaries, such as the location of alignment boundary A2, can depend on the location of an initial alignment boundary, such as the location of alignment boundary A1.

As shown in FIG. 1, the alignment boundary A1, which is an initial alignment boundary, has a predefined location that is near the left edge of each of the layout elements 13. In this embodiment, the alignment boundary A1 can have a predefined location along the left side of the each of the layout elements 13 because each of the variable-size fields 15 expands to the right (or contracts to the left) when the objects, which are textual objects that are aligned along the left edge of each of variable-size fields 15, included within each of variable-size fields 15. The size of each of the textual objects can expand to the right with the number of characters included in each of the textual objects.

The predefined location of the alignment boundary A1, in some embodiments, can be a fixed alignment location, which can be referred to as a starting alignment location or as a starting alignment position. In some embodiments, starting alignment location can be a default starting alignment location which is defined based on a default location. In some embodiments, the alignment boundary A1 can have a location that is a predefined spacing from the left edge of each of the layout elements 13. In some embodiments, alignment boundaries that are not the initial alignment boundary and/or do not have a predefined fixed position can be referred to as floating alignment boundaries or as variable location alignment boundaries.

Although not shown in FIG. 1, if the variable-size fields 15 were to include objects other than textual objects that are aligned along the left edge of each of the variable-size fields and expand in size to the right, the starting alignment location for an initial alignment boundary could be different. For example, if the variable-size fields were to include, for example, image objects or textual objects that change in size in a different direction than the right direction (i.e., Persian textual objects, Japanese textual objects), the initial alignment boundary can have a default starting alignment location, for example, centered within (or at a location offset from a center of) one or more of variable-size fields 15. In other words, in such embodiments, a variable-size field, such as one of the variable-size fields 15, can be centered about (or offset from) an initial alignment boundary (or another alignment boundary). One or more of alignment boundaries can have locations determined based on the initial alignment boundary, for example, in a location to the left of the initial alignment boundary or in a location to the right of the initial alignment boundary.

In some embodiments, a variable-size field can have a shape different than the variable-size fields 15 shown in FIG. 1. For example, a variable-size field can have a circular shape, a curved shape, a shape with more or less than four sides, and so forth. In some embodiments, only a single side of a variable-size field can change in length in accordance with a size of an object included within the variable-size field.

Although not shown, an additional alignment boundary, which can be disposed between the variable-size fields 12B and 14B and the fixed-size fields 12C and 14C, can be determined (e.g., defined, calculated). The additional alignment boundary can be defined so that a distance between the alignment boundary A2 and the additional alignment boundary will be greater than the predicted width of each of variable-size fields 12B and 14B when the textual objects (i.e., “text1,” “text123”) are respectively displayed therein. Accordingly, the fixed-size fields 12C and 14C can be aligned along the additional boundary (when actually displayed by the application display engine 131 of the layout manager 130) without overlapping with the variable-size fields 12B and 14B (when the fixed-size fields 12C and 14C are displayed).

In some embodiments, the boundary generator 133 can be configured to define the alignment boundary A1 and/or the alignment boundary A2 so that one or more of the fields 10 may be overlapping. For example, although not shown, the boundary generator 133 of the layout manager 130 can be configured to define the distance Q so that when variable-size field 12B is aligned along the alignment boundary A2, variable-size field 12B will be overlapping with at least a portion of variable-size field 12 A.

In some embodiments, the boundary generator 133 can be configured to define the alignment boundary A1 and/or the alignment boundary A2 so that a distance between the alignment boundary A1 and the alignment boundary A2 will include a default spacing. For example, the boundary generator 133 can be configured to define the distance Q so that the distance Q is greater than or equal to the horizontal dimension X plus a default spacing. In some embodiments, the distance Q can include more than one default spacing.

In some embodiments, a default spacing between an edge of a field and an alignment boundary can be determined based on a preference stored in, for example, the memory 140. The preference can be a preference defined by, for example, an administrator and/or a user. In some embodiments, the default spacing can be defined based on one or more portions of this set of instructions associated with the master layout element such as master layout element 27B. In some embodiments, the fields 10 can be separated by at least a minimum spacing, which can be defined within a preference or based on a set of instructions associated with the master layout element such as master layout element 27B.

As described above, the boundary generator 133 is configured to dynamically define the alignment boundaries A1 and A2 based on an analysis of the dimensions of variable-size fields 15 (i.e., variable-size field 12A and 14A) that are included in multiple layout elements 13 and based on the dimensions of objects that are to be included in the variable-size fields 15. If the dimensions of the objects that are to be included in the variable-size fields 15 are different than those shown in FIG. 1, the boundary generator 133 can be configured to define the alignment boundaries A1 and A2 accordingly. For example, if the dimensions of the textual objects that are to be included in the variable-size fields 12A and 14A are smaller than those shown in FIG. 1, the distance between the alignment boundaries A1 and A2 could be smaller than the distance Q shown in FIG. 1.

As shown in FIG. 1, the alignment boundaries A1 and A2 have been defined by the boundary generator 133 based on the maximum predicted width of variable-size field 12A or variable-size field 14A. In the embodiment shown in FIG. 1, the predicted width of the variable-size field 12A is larger than the predicted width of variable-size field 14 A. Accordingly, the distance between the alignment boundaries A1 and A2 is based on the predicted width of variable-size field 12 A.

In some embodiments, the alignment boundaries A1 and A2 can be defined based on a predicted dimension different than a maximum predicted width. For example, in some embodiments, alignment boundaries (such as alignment boundaries A1 and A2) can be defined based on, for example, an average predicted width, or even a minimum predicted width.

In some embodiments, the distance between a pair of alignment boundaries can be defined based on less than all of the variable size fields disposed between the pair alignment boundaries. The variable size fields that are excluded from the calculation of the distance between the pair alignment boundaries can be based on a preference stored in the memory 140 and/or based on a set of instructions associated with the variable size field that is excluded from the calculation.

Although not shown in FIG. 1, in some embodiments, multiple fields can be displayed between alignment boundaries such as alignment boundaries A1 and A2. For example, although not shown, the alignment boundaries A1 and A2 can be defined so that variable-size field 12A and variable-size field 12B can be disposed between the alignment boundaries A1 and A2. Accordingly, the distance between the alignment boundaries A1 and A2 can be defined based on the combined predicted width (and default spacings, if any) of both variable-size field 12A and variable-size field 12B.

In some embodiments, alignment boundaries such as alignment boundaries A1 and A2 can be defined based on any portion(s) of a layout element 13 that does not have a predefined dimension. For example, if layout element 12 had a horizontal dimension that was not predefined, a pair of alignment boundaries can be defined so that the left edge of layout element 12 can be aligned along a first alignment boundary from the pair of alignment boundaries and the right edge of layout element 12 can be aligned along a second alignment boundary from the pair of the alignment boundaries.

As shown in FIG. 1, the alignment boundaries A1 and A2 are oriented in a vertical direction and the fields 10 that are aligned along the alignment boundaries A1 and A2 are aligned in the vertical direction. For example, the variable-size fields 12A and 14A are aligned along the vertically-oriented alignment boundary A1. Also, as shown in FIG. 1, the fields within a particular layout element from the layout elements 13 are orthogonal to the alignment boundaries A1 and A2. For example, the fields included in layout element 12 (i.e., variable-size field 12A, variable-size field 12B, and fixed-size field 12C) are oriented along a horizontal line (not shown). In other words the fields included in layout element 12 are oriented horizontally.

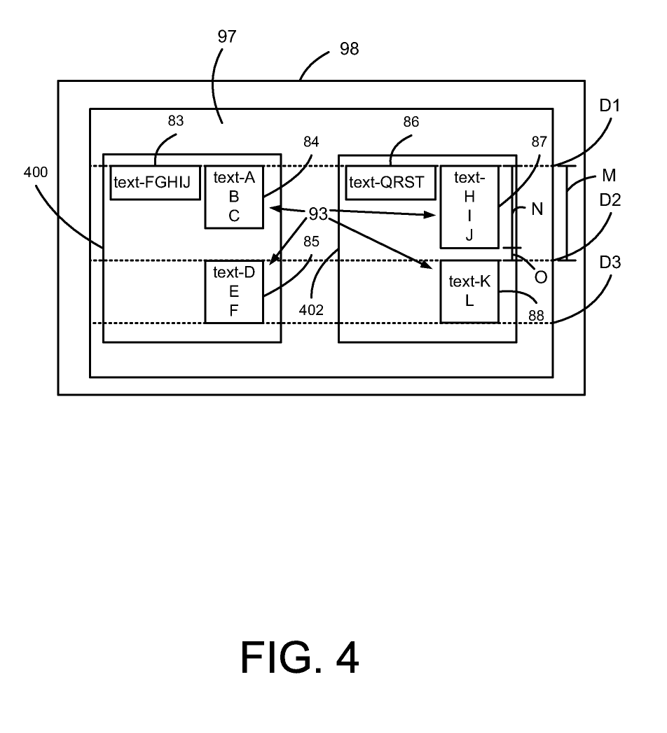

Although not shown in FIG. 1, in some embodiments alignment boundaries can be oriented in a direction different than a vertical direction. For example, alignment boundaries can be oriented in a horizontal direction, or any direction different than a horizontal direction or a vertical direction. More details related to an alignment boundary that is oriented in a direction different than a vertical direction are described in connection with FIG. 4.

Although not shown in FIG. 1, one or more alignment boundaries may not be parallel with one another. For example, alignment boundary A2 could be rotated slightly in a clockwise direction so that variable-size field 12B and variable-size field 14B could be aligned along the rotated alignment boundary A2 such that variable-size field 12B and variable-size field 14B do not overlap with variable-size field 12A and variable-size field 14A, respectively. In such embodiments, the alignment boundary A2 could be referred to as a slanted alignment boundary. The variable-size fields 15 could be aligned along the alignment boundaries A1 and A2 in this configuration because the variable-size field 14A has a horizontal dimension V that is smaller than a horizontal dimension X of variable-size field 12A. The portion of the slanted alignment boundary lateral to the variable-size field 14A can be separated from the alignment boundary A1 by a distance greater than the horizontal dimension V.

In some embodiments, one or more alignment boundaries may not be a straight line. For example, an alignment boundary can have a curved shape. In some embodiments, the shape of an alignment boundary can be defined based on a preference stored in, for example, the memory 140. In some embodiments, the shape of an alignment boundary can be determined by the boundary generator 133 based on an algorithm (e.g., a spline algorithm) and/or equation.

The alignment boundaries A1 and A2 can define at least a part of an alignment grid that is overlaid on top of the layout elements 13. In this embodiment, the alignment grid defined by the alignment boundaries A1 and A2 can supersede alignment as defined within the set of instructions associated with master layout element 27B. In other words, conflicts between alignment as defined within the set of instructions associated with the master layout element 27B and the alignment grid defined by alignment boundaries (such as alignment grid defined by the alignment boundaries A1 and A2) can be resolved so that portions of the layout elements 13, such as the fields 10, will be aligned with the alignment grid. In some embodiments, alignment as defined within the set of instructions associated with master layout element 27B can have priority over alignment boundaries such as the alignment boundaries A1 and A2.

As shown in FIG. 1, the layout manager 130 includes a layout customizer 135. The layout customizer 135 can be used, for example, by a user to define one or more master layout elements that can be included in the master layout elements 27. In other words, the user can, via the layout customizer 135, define a master layout element that can be used to create instances of layout elements within an application such as application 20 shown in FIG. 1. The layout customizer can be used to define the set of instructions that define a master layout element. In some embodiments, the layout customizer 135 can be used to modify one or more of the master layout elements 27.

In some embodiments, the master layout elements 27 can be, for example, defined as, or can include, any type of executable software module such as a computer program based on, but not limited to, micro-code or micro-instructions, machine instructions, such as produced by a compiler, code used to produce a web service, and files containing higher-level instructions that are executed by a computer using an interpreter. For example, one or more of the master layout elements 27 may be implemented using Java, C++, or other programming languages (e.g., object-oriented programming languages) and development tools. In some embodiments, one or more of the master layout elements 27 can be, or can be associated with, a background process with functionality that is not visible on the display 120. In some embodiments, one or more of the master layout elements 27 can define at least a portion of one or more applications or can be associated with one or more applications such as application 20.

Although not shown, in some embodiments, the memory 140 can be implemented as more than one memory component (e.g., more than one random-access memory (RAM) component or disk drive memory). In some embodiments, the memory 140 can be, or can include, a non-local memory (e.g., a memory not physically). For example, the memory 140 can be, or can include, a memory shared by multiple layout managers (not shown) such as layout manager 130. In some embodiments, the memory 140 can be associated with a server device (not shown) configured to service several layout managers.

In some embodiments, one or more portions of the components shown in the layout manager 130 in FIG. 1 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some embodiments, one or more portions of the application display engine 131 of the layout manager 130 can be, or can include, a software module configured for execution by at least one processor (not shown). In some embodiments, the functionality of the components can be included in different modules and/or components than those shown in FIG. 1. For example, although not shown, the functionality of the boundary generator 133 can be included in a different module than the boundary generator 133, or divided into several different modules.

Although not shown in FIG. 1, the display 120, the layout manager 130, and/or the memory 140 can be included in a device (or in multiple devices) such as a client device or a server device. Although not shown in FIG. 1, the device can be included in the network. In some embodiments, the network can include multiple devices (e.g., client devices, server devices). Also, although not shown in FIG. 1, the device(s) can be configured to function within various types of network environments. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can be have portions based on various protocols such as Internet Protocol (IP) and/or a proprietary protocol. The network can include at least a portion of the Internet.

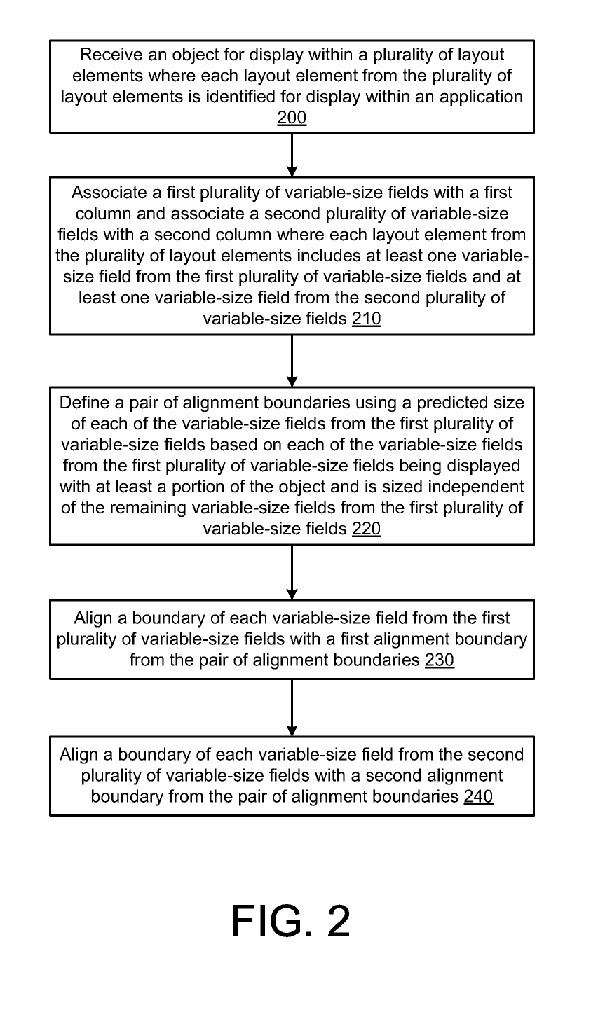

FIG. 2 is a flowchart that illustrates a method for displaying fields within layout elements during a layout process. In some embodiments, the method shown in FIG. 2 can be performed by a layout manager such as layout manager 130 shown in FIG. 1.

As shown in FIG. 2, an object for display within a plurality of layout elements is received (block 200). As shown in block 200, each layout element from the plurality of layout elements is identified for display within an application. In some embodiments, the object for display within the plurality of layout elements can be received by for example an object handler such as the object handler 134 shown in FIG. 1. In some embodiments each layout element from the plurality of elements can be an instance of a master layout element. The master layout element can be from a library of master layout elements that define a layout element database.

A first plurality of variable-size fields is associated with a first column and a second plurality of variable-size fields is associated with a second column (block 320). As shown in block 210, each layout element from the plurality of layout elements includes at least one variable-size field from the first plurality of variable-size fields and at least one variable-size field from the second plurality of variable-size fields. In some embodiments, the first plurality of variable size fields can be associated with the first column and the second plurality of variable size fields can be associated with by an application display engine (e.g., application display engine 131 shown in FIG. 1) and/or a boundary generator (e.g., boundary generator 133 shown in FIG. 1).

In some embodiments, the first plurality of variable-size fields can be associated with the first column based on a set of instructions indicating that the first plurality of variable-size fields should be associated with the first column. In other words, the set of instructions can specify, or can be used to determine, that the first plurality of variable-size fields are associated with the first column. Similarly, the second plurality of variable-size fields can be associated with the second column based on the set of instructions indicating that the second plurality of variable-size fields should be associated with the second column.

A pair of alignment boundaries using a predicted size of each of the variable-size fields from the first plurality of variable-size fields is defined based on each of the variable-size fields from the first plurality of variable-size fields being populated with at least a portion of the object and being sized independent of the remaining variable-size fields from the first plurality of variable-size fields (block 220). The pair of alignment boundaries can be defined before any of the variable-size fields from the first plurality of variable-size fields for the second plurality of variable-size fields are actually displayed within a display. In some embodiments, the pair of alignment boundaries can be vertically oriented within a display and/or within an application. The pair of alignment boundaries can be defined so that the distance between a first alignment boundary from the pair of alignment boundaries and a second alignment boundary from the pair of alignment boundaries is greater than a predicted width or height of any of the variable-size fields when including the object.

In some embodiments, the object can be represented as a textual object. Each of the variable-size fields from the first plurality of variable-size fields are sized independent of the remaining variable-size fields from the plurality of variable-size fields because each of the variable-size fields can be associated with an independently processed layout element. In some embodiments, at least some of the layout elements can be processing in a serial fashion or in parallel. In some embodiments, the pair of alignment boundaries can be defined by a boundary generator of a layout manager. In some embodiments, different objects such as an image can be included in the variable-size fields, in addition to, or in lieu of, the object.

A boundary of each variable-size field from the first plurality of variable-size fields is aligned with a first alignment boundary from the pair of alignment boundaries (block 230). The boundary of each variable-size field from the first plurality of variable-size fields can be aligned with the first alignment boundary via an application display engine. In some embodiments, the boundary of each variable-size field from the first plurality of variable-size fields can be an edge boundary.

A boundary of each variable-size field from the second plurality of variable-size fields is aligned with a second alignment boundary from the pair of alignment boundaries (block 240). The boundary of each variable-size field from the second plurality of variable-size fields can be aligned with the second alignment boundary via an application display engine. In some embodiments, the boundary of each variable-size field from the second plurality of variable-size fields can be an edge boundary. In some embodiments, the first alignment boundary may be non-parallel with the second alignment boundary. In some embodiments, the method shown in FIG. 1 can be adapted to alignment boundaries that are not vertically oriented within an application and/or within a display.

FIG. 3A is a block diagram that illustrates display of variable-size fields and fixed-size fields of layout elements within an application 71 when not aligned along one or more alignment boundaries. The application 71 is displayed within a display 72. As shown in FIG. 3A, the variable-size fields are associated with layout element 30, layout element 40, and layout element 50. Layout element 60 includes fixed-size fields 61 and fixed-size fields 62. FIG. 3B is a block diagram that illustrates display of the variable-size fields and fixed-size fields of layout elements shown in FIG. 3A when the variable-size fields are aligned along alignment boundaries. FIG. 3C is a block diagram that illustrates master layout elements included in a layout element database 340. The master layout elements shown in the layout element database 340 are used to define the instances of layout elements shown in FIGS. 3A and 3B.

Referring now to FIG. 3A, the lines B1, B2, and B3, which are displayed as dashed lines, are not alignment boundaries. These lines are included in FIG. 3A to illustrate the misalignment of the variable-size fields associated with the various layout elements. The lines B1, B2, and B3 are aligned with the variable-size fields included in layout element 30 as a point of reference. Specifically, lines B1 is aligned along the left edge of variable-size field 31. The line B2 is aligned along the left edge of the variable-size field 32 and the line B2 is aligned along the right edge of variable-size field 32.

As shown in FIG. 3A all of the fields include textual objects. For example, variable-size field 41 includes a textual object “text-a.” Although not shown, in some embodiments, one or more of the fields could include objects other than textual objects (e.g., image objects).

As shown in FIG. 3A, the line B2 is aligned along the left edge of variable-size field 32, and the variable-size fields 42, 52, and 53 are not aligned along line B2. The variable-size field 42, the variable-size field 53, and the variable-size field 52 are disposed on top of line B2. The variable-size field 52 and the variable-size field 53 are disposed on top of line B3, which is aligned along the right edge of variable-size field 32.

The variable-size field 31, the variable-size field 41, and the variable-size field 51, which are respectively associated with layout element 30, layout element 40, and layout element 50, are, by default, aligned along line B1. In this embodiment, because the variable-size fields 31, 41, and 51 are configured to expand to the right (or contract to the left) depending on the text included therein, the left edge of each of variable-size fields 31, 41, and 51 have a fixed starting alignment position aligned along line B1. In other words, line B1 can function as an initial alignment boundary.

In this embodiment, the layout element 60 has fields 61 and 62 that are not specified for alignment along alignment boundary. In other words, the layout element 60 is not selected for alignment. In some embodiments, the layout element 60, or portion thereof, may be determined as ineligible for alignment along an alignment boundary based on a set of instructions defining the layout element 60. In some embodiments, the layout element 60 can be disposed within a zone (e.g., a region, an area) that has been identified for exclusion from alignment. In some embodiments, the zone can be referred to as an exclusion zone. In some embodiments, an exclusion zone can include all or a portion of one or more layout elements.

FIG. 3B is a block diagram that illustrates display of the variable-size fields and fixed-size fields of layout elements shown in FIG. 3A when the variable-size fields are aligned along alignment boundaries. In this embodiment, the locations of alignment boundary C1, alignment boundary C2, and alignment boundary C3 are based on columns of variable-size fields. Specifically, the variable-size fields 31, 41, and 51 define a column of variable-size fields 81, and the variable-size fields 32, 42, 52, and 53 define a column of variable-size fields 82. The column of variable-size fields 81 can be referred to, in a shorthand fashion, as column 81, and the column of variable-size fields 82 can be referred to, in a shorthand fashion, as column 82. In this embodiment, each of the columns 81 and 82 includes a subset of the variable-size fields of each of the layout elements.

In this embodiment, the alignment boundaries C1 and C2 are defined so that the variable-size fields associated with column 81 are disposed between the alignment boundaries C1 and C2. Accordingly, the distance between the alignment boundaries C1 and C2 is defined based on the variable-size fields associated with column 81. Similarly, the alignment boundaries C2 and C3 are defined so that the variable-size fields associated with column 82 are disposed between the alignment boundaries C2 and C3. Accordingly, the distance between the alignment boundaries C2 and C3 is defined based on the variable size fields associated with column 82.

As shown in FIG. 3B, the alignment boundary C1 is located at a starting alignment position and is configured to function as an initial alignment boundary for column 81. The variable-size field 31, the variable-size field 41, and the variable-size field 51 (which define column 81) each have a left edge that is aligned along the alignment boundary C1. The alignment boundary C2, has a distance from alignment boundary C1 that is defined based on the predicted widths of each of the variable-size fields 31, 41, and 51 associated with column 81. In this case, the variable-size field 31 has the largest predicted width of the variable-size fields 31, 41, and 51 when a textual object is included in the variable-size field 31. Accordingly, the distance between the alignment boundary C1 and the alignment boundary C2 is defined so that the distance between the alignment boundary C1 and the alignment boundary C2 is larger than the predicted width of the variable-size field 31. In other words the distance between the alignment boundary C1 and the alignment boundary C2 is defined based on the largest predicted variable-size field width from the variable-size fields that define column 81.

As shown in FIG. 3B, the alignment boundary C3 has a location that is defined based on the location of the alignment boundary C2 and based on the predicted width of each of the variable-size fields 32, 42, 52, and 53 (which define column 82). Accordingly, the location of the alignment boundary C2 can be a starting location for defining the location (e.g., the horizontal location) of the alignment boundary C3. As shown in FIG. 3B, the predicted width of each variable-size fields 42, 52, and 53 is the same. Thus, the distance between the alignment boundary C2 and the alignment boundary C3 is greater than the predicted width of each of variable-size fields 42, 52, and 53 when their respective textual objects are included therein.

In some embodiments, the number of alignment boundaries can be correlated with the number of columns of variable-size fields. For example, at least three pairs of alignment boundaries can be defined for three columns of variable-size fields.

Each of the layout elements shown in FIG. 3B is an instance of a master layout element included in the layout element database 340 shown in FIG. 3C. As shown in FIG. 3C, the layout element database 340 includes master layout element MLE1, master layout element MLE2, and master layout element MLE3. Master layout element MLE1 includes 3 fields, master layout element MLE2 includes 2 fields, and master layout element MLE3 includes 4 fields.

Each of the master layout elements stored in the layout element database 340 includes different categories of fields. In this embodiment, the categories of fields are represented by the words in brackets. The master layout element MLE1 has a variable-size field M11 configured to receive a label-category textual object (as represented by “[label]” appearing in the variable-size field M11), a variable-size field M12 configured to receive a description-category textual object (as represented by “[desc]” appearing in the variable-size field M12), and a fixed-size field M13 configured to receive an description-type textual object. A label-category textual object can be a textual-object used as a label in, for example, a magazine, catalog, and/or database. A description category textual object can be a textual object used to, for example, describe the details associated with a label. The categories described above are presented by way of example only and different categories of objects can be used.

The fixed-size field M13 is defined so that a location of an alignment boundary is not defined based on the fixed-size field M13. In other words, the set of instructions defining the fixed-size field M13 are defined so that a layout manager such as layout manager 130 will not use a width of the fixed-size field M13 to define (e.g., determine the location of) an alignment boundary. Alternatively, the set of instructions defining the master layout element MLE1 can be defined so that only the variable-size fields M1 and M12 are used to define (e.g., determine the location of) an alignment boundary. In some embodiments, the layout element database 340 can be managed by a layout element manager such as layout element manager 132 shown in FIG. 1.

Referring back to FIG. 3B, layout element 30 and the layout element 40 are instances of the master layout element MLE1. The layout element 60 is an instance of the master layout element MLE2, and the layout element 50 is an instance of the master layout element MLE3.

Because the layout element 30 and the layout element 40 are instances of the master layout element MLE1, the fixed-size field 33 (which is included in layout element 30) and the fixed-size field 43 (which is included in layout element 40) are not used to determine the locations of the alignment boundaries C2 and C3. The fixed-size field 33 and the fixed-size field 43 are both instances of the fixed-size field M13 of the master layout element MLE1 shown in FIG. 3C. Accordingly, the widths of fixed-size field 33 and fixed-size field 43 are not used to define (e.g., determine the locations of) the alignment boundaries C1, C2 and/or C3 based on the set of instructions associated with layout element 30 and layout element 40. In this embodiment, the fixed-size field 33 and the fixed-size field 43 are aligned along the alignment boundary C1, which is at a starting alignment position. Although not shown in FIG. 3, in some embodiments, one or more variable-size fields can also be excluded from any calculations used to define one or more alignment boundaries based on at least a portion of a set of instructions used to define the variable-size field(s).

In some embodiments, the set of instructions defining the master layout elements of layout elements 30, 40, and 50 can be used to determine which fields should be associated with column 81 or column 82. For example, the set of instructions defining master layout element MLE1 can include one or more parameter values (e.g., tags, XML tags) that indicate the variable-size field M11 and variable-size field M12 are associated with different columns.

In some embodiments, the fixed-size field 33 and the fixed-size field 43 may not be used to define (e.g., determine the locations of) the alignment boundaries C1, C2 and/or C3 because the fixed-size field 33 and fixed-size field 43 span more than one column. For example, as shown in FIG. 3C, the fixed-size field 33 spans both column 81 and column 82. Accordingly, the fixed-size field 33 may be excluded from any calculations used to determine the locations of the alignment boundaries C1, C2 and/or C3, which are defined based on the columns 81 and 82. In some embodiments, one or more variable-size fields can also be excluded from any calculations used to define one or more alignment boundaries when the variable-size field(s) span columns.

Although not shown in FIG. 3, in some embodiments, fields associated with layout elements can be aligned along multiple layers of alignment boundaries. For example, a first set of fields can be associated with a first column and a second set of fields associated with the second column and can be used to define a set of alignment boundaries associated with the first layer of alignment boundaries. A third set of fields that span the first column and the second column can be used to define another set of alignment boundaries associated with a second layer of alignment boundaries.

Although not shown in FIG. 3, in some embodiments, alignment boundaries can be defined based on fields that are associated with a particular category. For example, a first set of variable-size fields of a particular category may be used to define an alignment boundary, and a second set of variable-size fields of another category may not be used to define the alignment boundary. The second set of variable-size fields may not be used define the alignment boundary even though the second set of variable-size fields are within the same column as the first set of variable-size fields.

As shown in FIG. 3B, the variable-size fields 31 and 32, which are used to define the alignment boundaries C2 and C3, are oriented along (and could be aligned along) a horizontal line (the horizontal line is not shown) that is orthogonal to the alignment boundaries C2 and C3. In other words, the variable-size fields 31 and 32 are oriented horizontally with respect to one another and are orthogonal to the alignment boundaries along which they are aligned.

Although not shown in FIG. 3B, in some embodiments, one or more layout elements can be aligned along one or more alignment boundaries. For example, a first layout element can be aligned along a first alignment boundary and a field within the first layout element can be aligned along a second alignment boundary. A second layout element or a field of the second layout element can be aligned along the first alignment boundary.

Although not shown in FIG. 3B, in some embodiments, layout elements can be nested within one another and the fields associated with the nested layout elements can be aligned along one or more alignment boundaries. For example, a first layout element can be nested within a second layout element. A variable-size field of the second layout element can be aligned along a starting alignment boundary, and a location of an additional alignment boundary can be defined (e.g., can be determined) based on a predicted width of the variable-size field of the second layout element. The first layout element, which is nested within the second layout element, can be aligned along the additional alignment boundary.

In some embodiments, one or more of the master layout elements, such as master layout element MLE1 shown in FIG. 3C, can be bound to (e.g., associated with) a datalist (e.g., a database). Entries within (e.g., data within) the datalist can be populated within instances of the master layout element MLE1 bound to the datalist and aligned along one or more alignment boundaries.

For example, a datalist may be bound to a master layout element. A first row of entries (e.g., data from the first row) from the datalist can be populated within fields (e.g., variable-size fields, fixed-size fields) of a first instance of the master layout element, and a second row of entries (e.g., data from the second row) from the datalist can be populated within fields (e.g., variable-size fields, fixed-size fields) of a second instance of the master layout element. The first instance of the master layout element and the second instance of the master layout element can be aligned along alignment boundaries in accordance with the techniques described in connection with FIGS. 3A through 3C. The number of instances of the master layout element can be correlated to the number of entries (e.g., rows of entries) included in the datalist.

In some embodiments, a single datalist can be bound to multiple master layout elements. For example, a datalist may be bound to a first master layout element and the datalist may be bound to a second master layout element. In some scenarios the data of the datalist may be populated within instances of the first master layout element in response to, for example, selection by a user, and in some scenarios, the data of the datalist may be populated within instances of the second master layout element in response to, for example, selection by a user.

In some embodiments, multiple different datalists can be bound to a particular master layout element. For example, a first datalist can be bound to a master layout element, and a second datalist can also be bound to the same master layout element. Accordingly, data from the first datalist can be populated within a first set of instances of the master layout element, and data from the second datalist can be populated within a second set of instances of the master layout element. The first set of instances of the master layout element can be aligned along the same or different alignment boundaries as the second set of instances of the master layout element.

In some embodiments, portions of a single datalist may be bound to multiple master layout elements. In some embodiments, a first portion of a datalist may be bound to a first master layout element, and a second portion of the datalist may be bound to a second master layout element different from the first master layout element. Accordingly, data from the first portion of the datalist can be populated within a set of instances of the first master layout element, and data from the second portion of the datalist can be populated within a set of instances of the second master layout element. The instances of the first master layout element can be aligned along the same or different alignment boundaries as the instances of the second master layout element.

In some embodiments, the master layout element can be bound to (e.g., associated with) the configuration of one or more alignment boundaries (after the locations of the alignment boundaries have been initially computed) as well as a datalist. In other words, the configuration of the alignment boundaries (e.g., the locations of the alignment boundaries) can be stored and then bound to (e.g., associated with) a particular master layout element and/or data list for later retrieval and use.

Although not shown in FIG. 3A or 3B, alignment boundaries can be oriented in a direction other than a vertical direction. An example of such an embodiment is shown in FIG. 4.

FIG. 4 is a block diagram that illustrates alignment of variable-size fields of layout elements along alignment boundaries that are horizontally oriented. The layout element 400 and the layout element 402 are displayed within an application 97. The application 97 is displayed within a display 98. The variable-size fields 93 of the layout elements 400 and 402 shown in FIG. 4 are configured to expand in a downward direction (or contract in an upward direction). In other words, the variable-size fields 93 are configured to expand in a vertically oriented direction rather than in a horizontally oriented direction. In this embodiment, layout element 400 and layout element 402 are instances of the same master layout element.

As shown in FIG. 4, the variable-size fields 84 and 87 have a top edge aligned along alignment boundary D1, which is at a fixed starting alignment position. The fixed starting alignment position is at the top portion of each of the layout elements 400 and 402. The alignment boundary D2 has a location (i.e., a vertical location) that is defined based on the widths of each of the variable-size fields 84 and 87. As shown in FIG. 4, a distance M between alignment boundary D1 and alignment boundary D2 is equal to a predicted width N and a default spacing O.

As shown in FIG. 4, the variable-size fields 85 and 88 each have a top edge aligned along the alignment boundary D2. The alignment boundary D3 has a location that is defined based on the widths of each of the variable-size fields 85 and 88. As shown in FIG. 4, the alignment boundary D3 is aligned along the lower edge of each of the variable-size fields 85 and 88. The lower edge of each of the variable-size fields 85 and 88 can be aligned along the alignment boundary spell D3, without a default spacing, based on a preference and/or based on a set of instructions associated with the common master layout element of layout element 400 and layout element 402.

The variable-size fields 84 and 87 can be disposed between the alignment boundaries D1 and D2 because the variable-size fields 84 and 87 are associated with a row. Similarly, the variable-size fields 85 and 88 can be disposed between the alignment boundaries D2 and D3 because the variable-size fields 85 and 88 are associated with another row. Although not shown, other fields (e.g., other variable-size fields) can be excluded from alignment based on a set of instructions associated with the common master layout element of layout element 400 and layout element 402 and/or if they span more than one row.

Although not shown in FIG. 4, in some embodiments the variable-size fields 93 could also be configured to expand in a horizontal direction. In such embodiments, vertically oriented alignment boundaries could also be defined. The variable-size fields could then be aligned along the vertically oriented alignment boundaries as well as along the alignment boundaries D1, D2, and D3, which are horizontally oriented. In such embodiment, the vertically oriented alignment boundaries and the horizontally oriented boundaries would define an alignment grid.

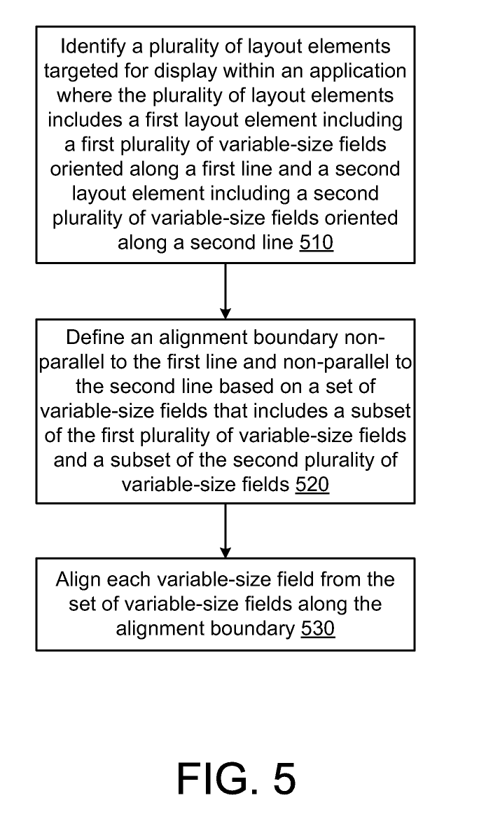

FIG. 5 is a flowchart that illustrates a method for defining an alignment boundary during a layout process. As shown in FIG. 5, a plurality of layout elements targeted for display within an application are identified (block 510). As shown in block 510, the plurality of layout elements includes a first layout element including a first plurality of variable-size fields oriented along a first line and a second layout element including a second plurality of variable-size fields oriented along a second line. In some embodiments, the plurality of layout elements targeted for display within the application can be identified by an application display engine such as the application display engine 131 shown in FIG. 1.

In some embodiments, one or more of the variable-size fields (from the first plurality of variable-size fields or the second plurality of variable-size fields) can be configured to expand (based on one or more objects included therein) in more than one direction. For example, if the first line is horizontally oriented, a variable-size field from the first plurality of variable-size fields can be configured to expand to the left along the first line and to the right along the first line when an object is included in the variable-size field. In some embodiments, objects to be included within the variable-size fields can be identified by an object handler such as object handler 134 shown in FIG. 1.

An alignment boundary nonparallel to the first line and non-parallel to the second line are defined based on a set of variable-size fields that includes a subset of the first plurality of variable-size fields and a subset of the second plurality of variable-size fields (block 520). In some embodiments, the alignment boundary can be horizontally oriented and the first line can be vertically oriented, or vice versa. In some embodiments, the alignment boundary can be defined by a boundary generator such as boundary generator 133 shown in FIG. 1.

Each variable-size field from the set of variable-size fields are aligned along the alignment boundary (block 530). In some embodiments, each variable-size field from the set of variable-size fields can be aligned along the alignment boundary by an application display engine such as application display engine 131 shown in FIG. 1.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device (computer-readable medium) or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a LAN and a WAN, e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments. It should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described.

What is claimed is:

1. A computer system including instructions stored on a non-transitory computer-readable storage medium, the computer system comprising:
a data handler configured to receive data for display within a plurality of layout elements, each layout element from the plurality of layout elements being identified for display within an application;
a boundary generator configured to associate a first plurality of variable-size fields with a first column and associate a second plurality of variable-size fields with a second column,
each layout element from the plurality of layout elements including at least one variable-size field from the first plurality of variable-size fields and at least one variable-size field from the second plurality of variable-size fields,
the boundary generator configured to define a pair of alignment boundaries using a predicted size of each of the variable-size fields from the first plurality of variable-size fields, the predicted size of each of the variable-size fields from the first plurality of variable-size fields being based on each of the variable-size fields from the first plurality of variable-size fields being populated with at least a portion of the data and being sized independent of the remaining variable-size fields from the first plurality of variable-size fields; and
an application display engine configured to align a boundary of each variable-size field from the first plurality of variable-size fields with a first alignment boundary from the pair of alignment boundaries,
the application display engine configured to align a boundary of each variable-size field from the second plurality of variable-size fields with a second alignment boundary from the pair of alignment boundaries.

2. The computer system of claim 1, wherein each layout element from the plurality of layout elements is an instance of the same master layout element, the master layout element is defined by a plurality of instructions,
each of the variable-size fields from the first plurality of variable-size fields is sized independent of the remaining variable-size fields from the first plurality of variable-size fields on a per layout element basis based on at least a portion of the plurality of instructions.

3. The computer system of claim 1, wherein the application display engine is configured to select the plurality of layout elements in response to an instruction received from the application,
the computer system further comprising:
a layout element database including a first master layout element and a second master layout element different from the first master layout element,
the plurality of layout elements including a first layout element that is an instance of the first master layout element, the plurality of layout elements including a second layout element that is an instance of the second master layout element.

4. The computer system of claim 1, wherein at least one of the layout elements from the plurality of layout elements includes a variable-size field that is excluded from the first plurality of variable-size fields and excluded from the second plurality of variable-size in response to the boundary generator determining, based on a boundary condition, that the variable-size field spans the first column and the second column.

5. The computer system of claim 1, wherein the boundary generator is configured to position the first alignment boundary with a fixed orientation within the application before the boundary of each of the variable-size fields from the first plurality of variable-size fields are aligned by the application display engine with the first alignment boundary.

6. The computer system of claim 1, wherein the boundary generator is configured to define a distance between the pair of alignment boundaries such that the predicted width of each of the variable-size fields from the first plurality of variable-size fields is less than the distance.

7. The computer system of claim 1, wherein the first column and the second column are substantially parallel to the first alignment boundary.

8. The computer system of claim 1, wherein the boundary generator is configured to associate the first plurality of variable-size fields with the first column based on each variable-size field from the first plurality of variable-size fields being a first type of variable-size field,
the boundary generator is configured to associate the second plurality of variable-size fields with the second column based on each variable-size field from the second plurality of variable-size fields being a second type of variable-size field different from the first type of variable-size field.

9. The computer system of claim 1, wherein the plurality of layout elements includes a layout element including a first variable-size field from the first plurality of variable-size fields and a second variable-size field from the second plurality of variable-size fields, the first variable-size field and the second variable-size field being aligned along a line substantially orthogonal to the pair of alignment boundaries.

10. The computer system of claim 1, wherein the boundary generator is configured to define a third alignment boundary non-parallel to the first alignment boundary and non-parallel to the second alignment boundary,
the application display engine configured to align a third plurality of variable-size fields along the third alignment boundary.

11. The computer system of claim 1, wherein the at least one variable-size field from the first plurality of variable-size fields and the at least one variable-size field from the second plurality of variable-size fields are oriented substantially along a horizontal line within each of the layout elements from the plurality of layout elements, the first column and the second column are substantially orthogonal to the horizontal lines of the plurality of layout elements.

12. The computer system of claim 1, further comprising:
a layout customizer configured to store in a layout element database a customized master layout element defined on a client side of a network, the plurality of layout elements including a first layout element that is an instance of the customized master layout element,
the plurality of layout elements including a second layout element that is an instance of a master layout element defined on a server side of the network and stored in the database of layout elements.

13. A method including executing instructions recorded on a non-transitory computer-readable storage media using at least one processor, the method comprising:
identifying a plurality of layout elements targeted for display within an application, the plurality of layout elements including a first layout element including a first plurality of variable-size fields oriented along a first line, the plurality of layout elements including a second layout element including a second plurality of variable-size fields oriented along a second line,
the first plurality of variable-size fields from the first layout element being defined such that defining of a variable-size portion of each variable-size field from the first plurality of variable-size fields, when populated with a first portion of data and displayed within the first layout element, is independent from defining of a variable-size portion of each variable-size field from the second plurality of variable-size fields when populated with a second portion of the data and displayed within the second layout element; and
defining an alignment boundary non-parallel to the first line and non-parallel to the second line based on a set of variable-size fields that includes a subset of the first plurality of variable-size fields and a subset of the second plurality of variable-size fields.

14. The method of claim 13, wherein the alignment boundary is associated with a layout layer that has priority over a layout layer of the first plurality of variable-size fields and the second plurality of variable-size fields.

15. The method of claim 13, wherein the alignment boundary includes a first alignment boundary,
the method further comprising:
determining a predicted width of each of the variable-size fields from the set of variable-size fields; and
defining a second alignment boundary substantially orthogonal to the first line and substantially orthogonal to the second line such that the predicted width of each of the variable-size fields from the set of variable-size fields combined with a default spacing is less than a distance between the second alignment boundary and the first alignment boundary.

16. A non-transitory computer-readable storage medium storing code representing instructions that when executed are configured to cause a processor to perform a process, the code comprising code to:
receive a plurality of instructions defining a layout element stored in a layout element database, at least a portion of the plurality of instructions defining a variable-size field within the layout element;
receive a first data identified for display in a first instance of the variable-size field in a first instance of the layout element;
receive a second data identified for display in a second instance of the variable-size field in a second instance of the layout element;
predict that a size of a variable-size portion of the second instance of the variable-size field, when the second data is displayed within the second instance of the variable-size field, is greater than a size of a variable-size portion of the first instance of the variable-size field when the first data is displayed within the first instance of the variable-size field; and
define an alignment boundary within an application based on the size of the variable-size portion of the second instance of the variable-size field, the application being a placement target of the first instance of the layout element and the second instance of the layout element.

17. The non-transitory computer-readable storage medium of claim 16, wherein the variable-size field is a first variable-size field,
the code further comprising code to:
designate an instance of a second variable-size field as a non-aligning variable-size field.

18. The non-transitory computer-readable storage medium of claim 16, wherein the variable-size field is designated for alignment based on a layout preference.

19. The non-transitory computer-readable storage medium of claim 16, further comprising code to:
align the first instance of the variable-size field along the alignment boundary during a first time period when the first instance of the layout element is placed within the application; and
align the second instance of the variable-size field along the alignment boundary during a second time period when the second instance of the layout element is placed within the application, the first instance of the variable-size field is independently sized from the second instance of the variable-size field.

20. The non-transitory computer-readable storage medium of claim 16, further comprising code to:
define a second alignment boundary that does not intersect the second instance of the variable-size field when the second data is displayed within the second instance of the variable-size field or does not intersect the first instance of the variable-size field when the first data is displayed within the first instance of the variable-size field.
